(19) United States
(12) Patent Application Publication
(10) Pub. No.: US 2002/0189967 A1
(43) Pub. Date: Dec. 19, 2002

(54) Package for compounding rubber, compounded rubber and tire having tread thererof

(75) Inventors: James Robert McCandless, Uniontown, OH (US); Bharat Kanchanlal Kansupada, Mogadore, OH (US)

Correspondence Address: The Goodyear Tire & Rubber Company, Department 823, 1144 EAST MARKET STREET, Akron, OH, 44316-0001, US

(73) Assignee: The Goodyear Tire & Rubber Company.

(21) Appl. No.: 09/828,586

(22) Filed: Apr. 5, 2001

Related U.S. Application Data
(63) Continuation of application No. 09/027,786, filed on Feb. 23, 1998, now abandoned.
Application No. 09/027,786 is a continuation-in-part of application No. 08/709,374, filed on Sep. 6, 1996, now abandoned.

(51) Int. Cl. C08L 33/04

(52) U.S. Cl. 206/524.4; 525/222; 206/524.6; 206/524.7

(57) ABSTRACT

A package comprised of at least one compounding ingredient for unvulcanized rubber contained in a very thin, low softening point film having a relatively high resistance to tear (Elmendorff MD tear values, in a range of about 215 to about 350 grams and TD tear value in a range of about 350 to about 630 grams, at about 23° C.) comprised of an ultra low density polyethylene which is required to contain calcium carbonate. The invention also relates to compounding rubber with such a package and to rubber compositions prepared thereby. The invention further relates to rubber products of such rubber compositions including tires with components thereof, particularly tire treads, as well as industrial products such as hoses and belts.

### TECHNICAL FIELD

This invention relates to packaged materials for compounding rubber, to rubber compounded therewith and to products such as tires and industrial product having components thereof, particularly to a tire with a tread of such compounded rubber. The packaging material for this invention is a very thin, low softening point film with relatively high resistance to tear.

### BACKGROUND

Compounding ingredients for rubber compositions are sometimes pre-packaged in a film bag and the entire package, including its film, introduced into an internal rubber mixer and mixed with the rubber composition.

It is recognized that relatively low melting point thermoplastic films have heretofore been used for such purpose.

However, it is considered herein that there is a need and desire to provide such a package using a film that not only has a relatively low softening point but, as a very thin film, also has greater strength.

Indeed, it is desired to provide such a package with a film which (1) has a softening point of about 75° C., or lower, so that it can be more readily mixed in a rubber composition at temperatures as low as 95° C., (2) is very thin so that it can be mixed relatively efficiently with a rubber composition, (3) and have sufficient strength for handling in the work place prior to being introduced into the rubber composition.

The strength requirement for the film, as well as desirability for a low stretch film, is considered herein to be a significant aspect of the invention in order to reduce tendencies for a filled bag of rubber compounding ingredients from tearing and spilling the ingredients into the workplace, particularly where the film for the package is very thin and has a low softening point. Also, a desirability for a relatively low stretch film is so that the bag can readily be picked by a user with one hand instead of using two hands in the workplace to transport the filled bag.

The strength factor for the film is represented by Elmendorff tear values.

In practice, it is contemplated that such film may be manufactured by bubble blowing for optimal film properties. Such manufacturing processes for preparation of thermoplastic films is well known to those having skill in such art.

Providing a film with suitable Elmendorff tear values is considered herein to be a rather stringent challenge, taking into consideration that it is desired that the film be very thin and, also, have a relatively low softening point.

In the mixing of rubber compositions, a typical final mixing stage, where curatives such as sulfur and cure accelerators are added, is operated at reduced mixing temperatures such as, for example, about 95° C. to about 120° C. for relatively short periods of time. This compares with temperatures in a range of about 140° C. to about 150° C. for mixing stages preceding the final mixing stage. It is in such circumstance, namely for the final mixing stage, that the film compositions of this invention have particular value in that they are thin, have a relatively low softening point for the mixing purposes, yet have a suitable Elmendorff tear value for handling purposes.

In particular, for the aforesaid thermoplastic film to be satisfactory for introducing rubber compounding ingredients into such final, curative addition mixing stage, not only should the film have a softening point below the mixing stage's rubber composition mixing temperature, but the film should be relatively thin in order to adequately disperse within the compounded rubber at the aforesaid mixing temperature of 95° C. to 120° C. and in a relatively short period of time.

A suitable overall strength of the film, in addition to the aforesaid Elmendorff tear values, can be determined, for example, by substantially filling a bag composed of the thermoplastic film having a thickness of about 1.6 to about 2 mils, or about 0.04 to about 0.05 millimeters, and at about 23° C. with about 35 pounds (about 16.4 kg) of one or more granular rubber compounding ingredients without rubber processing oil. The bag is than dropped from a height of about four feet (about 12 meters) onto a hard, smooth surface for four to five sequential drops. The bag is considered as passing the test if the bag does not rupture with an attendant spilling of a portion of the ingredients onto the hard surface. This test is referred to herein as a “drop test”, or “GT-D test”.

Thus, the selection of a suitable film may ultimately require a determination by experimentation concerning its overall strength.

Polyethylene, while it has been used for rubber packaging and sometimes rubber compounding ingredient packaging in some circumstances, is often considered to be disadvantageous because, when mixed with unvulcanized rubber, it does not usually disperse sufficiently well, for the purposes of this invention, in the rubber blend at a temperature of about 95° C. to about 100° C.

Historically, films of ethylene/vinyl acetate copolymer and of syndiotactic polybutadiene have been used for packaging rubber compounding ingredients for rubber mixing purposes.

Also, syndiotactic polybutadiene has been used for such purpose but has a softening point higher than desired for some purposes (e.g. 92° C.) and has in sufficient chemical resistance to unsaturated fatty acids.

In the description of this invention, the term “phr” relates to “parts by weight per 100 parts by weight rubber”.

In general, the parts and percentages referred to herein may be considered as being by weight unless otherwise designated.

A softening point of polymers, as used in the description of this invention may conveniently be determined by DSC (differential scanning calorimetry) analysis with a rate of temperature rise of 10° C. per minute. Such technique is well known to those having skill in such art. Some polymers exhibit a rather broad melting “point” and so is referred to herein as “a softening point”.

The Elmendorff tear value may be determined by ASTM Test No. D1922 provided, however, that four or five data points are usually taken from a particular film and about four to five samples of film are analyzed, thereby resulting in 16 to 25 samplings. A mean value of such data points is obtained for a particular film from the samplings.

### DISCLOSURE AND PRACTICE OF INVENTION

In accordance with this invention a package is provided which comprises (A) compounding ingredients for unvulcanized rubber, exclusive of unvulcanized rubber itself, packaged in (B) a protective film having a thickness in the range of about 1.6 to about 2 mils, or about 0.04 to about 0.05 mm, of a thermoplastic film where, based on 100 parts by weight, such thermoplastic film is comprised of (i) a blend of an ultra low density polyethylene (ULDPE) and about 7.5 to about 30, preferably about 12 to about 25, weight percent particulate calcium carbonate based upon the ULDPE, wherein said ULDPE is a copolymer of about 70 to about 85 percent units derived from ethylene and, correspondingly about 30 to about 15 percent units derived from an aliphatic monoolefin containing 6 to 8 carbon atoms, preferably hexene and/or octene; wherein said calcium carbonate has an average particle size in a range of about one to about three microns; and where said film is characterized by having a softening point in the range of about 68° C. to about 75° C., preferably about 68° C. to about 74° C. and an Elmendorff (ASTM D1922) MD (machine direction) tear value in a range of about 215 to about 360 grams and TD (transverse direction) tear value in a range of about 360 to about 630 grams; wherein said ULDPE polymer itself has a softening point within a range of about 68° C. to about 75° C.

The ULDPE and film are reported as above as having a softening point in a range of about 68° C. to about 75° C. Thus, it is contemplated that they have similar or nearly identical softening point ranges which are intended to include about 68° C. to about 75° C. softening points.

Typically, the ULDPE has a specific gravity in a range of about 0.88 to about 0.89.

It is understood that the film composite blend of this invention desirably can contain various typical lubricants, fillers, pigments and dyes and stabilizers.

In one aspect of the practice of this invention, preferably the compounding ingredients are comprised of sulfur and cure accelerators and the mixing temperature of the rubber composition is in a range of about 80° C. to about 120° C.

The ultra low density polyethylene (ULDPE) thermoplastic required by this invention is readily distinguished from low density polyethylene (LDPE), since LDPE, in contrast, is understood to typically have a softening point in a range of about 100° C. to about 115° C., and a specific gravity in a range of about 0.9 to about 0.92. It is understood that an LDPE may be a copolymer of about 90 to about 95 percent ethylene and about 5 to about 10 percent of a low molecular weight diene.

In practice, for the ULDPE copolymer composed of both units derived from ethylene and aliphatic monoolefin, the monoolefin is preferably selected from hexene and octene.

In the practice of this invention, a method of compounding rubber is provided and the resulting compounded rubber, which comprises mixing unvulcanized rubber, particularly high unsaturation rubber, with the package of this invention containing conventional rubber compounding ingredients optionally followed by sulfur curing said prepared mixture of rubber, packaging film and packaged ingredients. The invention is intended to be applicable where about 2 to about 40 and even up to about 90 phr of rubber processing oil is mixed with the rubber, usually exclusive of (in addition to) the ingredients in the said package.

In a further practice of this invention, such rubber composition is molded and sulfur vulcanized under conditions of elevated temperature (140° C. to 160° C.) and pressure to form a shaped rubber product.

In an additional practice of this invention, a tire is provided having a component composed of such shaped and cured rubber composition such as a circumferential tread.

In one and preferable aspect of this invention, the aforesaid package is of compounding ingredients comprised of, often preferably consisting essentially of, sulfur, sulfur cure accelerator(s), sometimes referred to as sulfur cure activators, for rubber and where it is understood that one or more antidegradants may be present. Such types of curative materials are well known to those having skill in the rubber compounding art. As mentioned herein, such ingredients can also contain a very, very small amount of oil.

In another aspect of this invention, a method of compounding rubber comprises the steps of (A) blending an unvulcanized unsaturated diene-based rubber (for example, styrene/butadiene copolymer elastomers whether organic solution polymerization prepared or aqueous emulsion polymerization prepared, cis 1,4-polyisoprene, cis 1,4-polybutadiene, isoprene/butadiene, styrene/isoprene/butadiene, 3,4-polyisoprene, and the like) and rubber compounding ingredients therefor, exclusive of sulfur and sulfur cure accelerators therefor in at least one non-productive mixing stage and (B) in a subsequent productive mixing stage, blending at least one package comprised of often preferably consisting essentially of, sulfur and sulfur cure accelerator(s) for rubber in a bag of said thermoplastic film with such non-productive blend (A).

Various rubber compounding ingredients, exclusive of the rubber itself, are contemplated for packaging according to this invention and then compounded with unvulcanized rubber. Representative of the various contemplated compounding ingredients are fillers, such as clay, silica, silicates, calcium carbonate, accelerators such as, for example, tetramethylthiuram disulfide, benzothiazyl disulfide and the like; antioxidants and antiozonants, curatives such as sulfur and accelerators, titanium dioxide, reinforcing pigments, such as carbon black, zinc oxide and hydrated silicon compounds; and processing aids, such as silicon dioxide, pumice, and stearate and which can include a very small amount of rubber processing oil when mixed with at least one other of such compounding ingredient.

In this manner, while the term “packaged” primarily relates to “bagged compounding ingredients”, it can also relate to compounding ingredients which are otherwise wrapped in the film.

For the purposes of the description of this invention, the term “rubber compounding ingredients”, to be packaged with the said thermoplastic film for the productive mix stage, does not include any substantial amount of rubber processing oils, except for a very small amount which aids in the reduction of dusting of the compounding ingredients which is typically less than about 2 phr.

Films of this invention have been observed to disperse readily in a rubber compound when using conventional rubber mixing equipment.

The practice of this invention is further illustrated by reference to the following examples which is intended to be representative rather than restrictive of the scope of the invention. Unless otherwise indicated, all parts and percentages are by weight.

### EXAMPLE I

Thermoplastic films, having a thickness of about 1.6 to about 2 mils, or about 0.04 to about 0.05 mm, were evaluated for use as a packaging material for rubber compounding ingredients to be used for mixing with rubber.

The thermoplastic films were blends of ultra low density polyethylene (ULDPE) with particulate calcium carbonate.

The blends are illustrated in the following Table 1 and referenced herein as Film A, Film B and Film C with the amounts of ULDPE and calcium carbonate being reported as parts by weight based on 100 parts by weight of the ULDPE. Each of the films also contained small amounts of lubricant(s), filler(s), stabilizer(s) and dye.

The thermoplastic films were evaluated for various physical and observed properties reported in the following Table 1. The control film contains no calcium carbonate and Films A-F contain various amounts of calcium carbonate. The ULDPE for the film is comprised of a copolymer of about 80 weight percent units derived from ethylene and about 20 weight percent units derived from hexene.

TABLE 1

| | Control | Film A | Film B | Film C | Film D | Film E | Film F |
|---|---|---|---|---|---|---|---|
| ULDPE¹ | 100 | 90 | 90 | 85 | 80 | 80 | 86 |
| Calcium | 0 | 10 | 10 | 15 | 20 | 20 | 14 |
| Carbonate² | | | | | | | |
| Film | 2.2-3 | 1.2-1.4 | 1.9-2 | 1.5-1.9 | 1.2-1.4 | 1.8-2 | 1.6-1.9 |
| Thickness | 0.06-0.08 | 0.03-0.04 | about 0.05 | 0.04-0.05 | 0 03-0.04 | 0.04-0.05 | 0.04-0.05 |
| mils & mm | | | | | | | |
| Melting point | 75 | 69-72 | 69-72 | 69-72 | 69-72 | 69-72 | 75 |
| (° C.) | | | | | | | |
| Elmendorff | | | | | | | |
| tear (grams) | | | | | | | |
| MD³ | 140 | 225 | 225 | 209 | 322 | 179 | 250 |
| standard | 4 | 16 | 13 | 13 | 29 | 18 | 36 |
| deviation +/− | | | | | | | |
| TD³ | 185 | 394 | 326 | 344 | 331 | 342 | 317 |
| standard | 13 | 11 | 7 | 20 | 23 | 23 | 54 |
| deviation +/− | | | | | | | |
| Bag drop test | passed | failed | failed | failed | passed | passed | passed |
| GT-D | | | | | | | |
| Stretchy bags | yes | no | no | no | no | no | no |

1. Ultra low density polyethylene copolymer obtainable from Exxon Chemical Company understood to be composed of about 80 percent units derived from ethylene and about 20 percent units derived from hexene and having a specific gravity of about 0.89, and a softening point of about 68° C. to 75° C. The units derived from hexene may vary somewhat depending upon the desired softening point. A higher hexene content generally results in a lower softening point and often in a lower Elmendorff tear value.

2. Calcium carbonate from the Luzenac America Company having an average particle size of about one to about three microns.

3. The Elmendorff Tear values (ASTM D1922) are the values in grams for machine direction (MD) and transverse direction (TD) with the deviation values reported below of each of the MD and TD values. The test was run at about 23° C. Higher values represent greater resistance to tear.

The results shown in Table 1 indicate that films of ULDPE (hexane) containing 15 and 20 percent of the calcium carbonate (Films D, E and F, respectively) had considerably higher Elmendorff MD tear resistance, an ASTM D1922 procedure) than the Control Film which contained no calcium carbonate.

It is considered herein that, of the seven films tested, Films D, E and F would be preferable for use in rubber compounding operations because their tear resistance and non-stretchy ability containing 35 pounds (16.4 kg) of compounding ingredients in the drop test (GT-D) which is considered herein to be particularly advantageous because of high tear resistance at low film thickness and ease of handling, (non-stretchiness) and ease of dispersion in the rubber composition.

Accordingly, Films D, E and F were selected for their relative strength and chemical stability as well as rubber composition dispersibility properties. In practice, it was found that some, namely a relatively small percentage, of the bags of the Control Film containing rubber compounding ingredients, tore too easily to be practical for use in extended rubber product manufacturing operations, at least as compared to bags prepared from Films D, E and F.

### EXAMPLE II

A series of individual bags, each composed of individual sheets of Films D, E and F and the Control Film as a control, were subjected to a relative strength (the GT-D drop test) and chemical stability test. Each of the bags had dimensions of about 23 inches by 26 inches, or about 58 cm by about 66 cm, and composed of the respective film folded with its two sides heat sealed thereby leaving its top open.

For the GT-D drop test, a series of each of the bags of the film bags was each filled with about 36 pounds, or about 16.4 kg, individually, with non-reactive phenolformaldehyde resin, paraphenylene diamine and oil treated sulfur. The bags passed the GT-D drop test.

Representative bags were also lifted from the floor to see if they could be easily lifted with one hand without substantially stretching, thereby desirably needing two hands to lift the bags from the floor. Bags of Films D, E and F passed the stretch test as reported in Table 2.

For the chemical stability test, three to four pounds (about 1.4 to 1.8 kg) of individual bags of oleic acid, of naphthenic oil and of hexamethoxymelamine were prepared, thus, representing three bags. Also about 30 pounds (about 14 kg) of individual bags of other ingredients, namely sulfur, zinc oxide, antioxidant and stearic acid, were prepared, thus, representing an additional five bags to be tested. The bags were then stored for about 7 days, at room temperature, or at about 23° C., except for the bags of oleic acid, naphthenic oil and hexamethoxymelamine which were stored for about 24 hours, following which they were each lifted without supporting the bottom of the bags.

The bags made, individually, of the Films D, E and F did not rupture or tear. Therefore, the Films were considered to have passed the relative strength (drop test), chemical stability test and stretch test which is, for convenience, referred to herein as test GT-C.

### EXAMPLE III

Films D, E and F were individually evaluated for their dispersibility in rubber. For such evaluation, the films were cut into square pieces with a dimension of about 1 inch by 1 inch (2.5 by 2.5 cm) and blended in a rubber composition mixture, in amounts representing about five times (5×) an amount considered to be representative, or typical, of the quantity of film which could be expected to be introduced into the rubber if the rubber cure compounding ingredients for a productive rubber mix stage were to be used. For this Example, such typical amount of film for a bag to be used in the productive mix stage was deemed to be about 0.02 phr.

The rubber composition used for the film dispersibility test was comprised of the following formulation shown in Table 2.

TABLE 2

| Material | Parts (Rounded) |
|---|---|
| A. First Mixing Stage (about 115° C.)¹ | |
| SBR Rubber, oil extended | 137.5 |
| (37.5 phr oil) | |
| Carbon Black (N110) | 130 |
| Rubber Processing Oil | 32 |
| Tackifier Resin | 21 |
| Stearic Acid | 5 |
| Zinc Oxide | 5 |
| Antidegradant(s) | 2 |
| B. Second Mixing Stage (about 95° C.)¹ | |
| Film | 0.02 |
| Accelerator, Sulfenamide Type | 3 |
| Tetramethyl Thiuram Disulfide | 1.5 |
| Sulfur | 1 |

¹Films D, E and F, respectively, in separate batches of the formulation.

The rubber compositions (Ex D, Ex E and Ex F, individually) were discharged from the second, productive internal rubber mixer when the mixture reached about 95° C. and were visually inspected for any undispersed film. No undispersed film was observed, indicating that the dispersion test was successful for the Films D, E and F.

The rubber blend was then banded on a cylindrical mill and samples taken for visual evaluation for dispersibility of the film in the rubber. No clumps of film or other residue of film was observed in the rubber composition, also indicating that the dispersion test was successful for the Films D, E and F.

### EXAMPLE IV

Samples of the rubber compositions were prepared according to Example III, which contain the Film D in 5× amount (referred to herein as composition Ex D5.) Samples of the rubber compositions were prepared according to Example III, which contain the Film E in 5× amount (referred to herein as composition Ex E5.) Samples of the rubber compositions were prepared according to Example III, which contain the Film F in 5× amount (referred to herein as composition Ex F5.) Samples of the rubber compositions (about 4 inches by about 6 inches, or about 10 cm by about 15 cm) were prepared and cured at about 150° C. for about 18 minutes and cross-sections of the cured samples visually examined. No clumps or pieces of the film were observed in the cured sheet, further indicating that the Films D, E and F passed the rubber composition dispersibility test.

Therefore, it is considered that Films D, E and F passed the rubber dispersibility test according to the physical properties of the resultant cured rubber being similar to those of the control, without any of the Films and, thus, not appreciably affected by the presence of the dispersed film.

In conclusion, results of the tests of Examples I, II, III and IV show that the ULDPE/calcium carbonate film, and particularly Films D, E and F, passed tests designed to determine their suitability for use as packaging films for rubber compounding ingredients which are to be mixed and cured with sulfur vulcanizable rubber in a rubber manufacturing operation.

While certain representative embodiments and details have been shown for the purpose of illustrating the invention, it will be apparent to those skilled in this art that various changes and modifications may be made therein without departing from the spirit or scope of the invention.

What is claimed is:

1. A package characterized by comprising (A) compounding ingredients for unvulcanized rubber packaged in (B) a protective film having a thickness in the range of about 1.6 to about 2 mils, (about 0.04 to about 0.05 mm) of a thermoplastic film, where, based on 100 parts by weight, such thermoplastic film is composed of a blend of an ultra low density polyethylene (ULDPE) and about 7.5 to about 30 weight percent calcium carbonate based on said ULDPE, said ULDPE as a copolymer of 70 to 85 percent units derived from ethylene and, correspondingly 30 to 15 percent units derived from one or more aliphatic monoolefins containing from 6 to and including 8 carbon atoms wherein said calcium carbonate has an average particle size in a range of about one to about three microns; wherein said film is characterized by having an Elmendorff MD tear value (23° C.) in a range of about 215 to about 360 grams and TD tear value (23° C.) in a range of about 360 to about 630 grams, a softening point in the range of about 68° C. to about 75° C.; wherein said ULDPE copolymers have a specific gravity within a range of 0.88 to 0.89 and a softening point within a range of about 68 to about 75° C.

2. The package of claim 1 where said film is comprised of ULDPE as a copolymer of ethylene and hexene.

3. The package of claim 1 where said film is comprised of ULDPE as a copolymer of ethylene and octene.

4. The package of claim 1 where said compounding ingredients are comprised of at least one of clay, silicates, calcium carbonate, tetramethylthiuram disulfide, benzothiazyl disulfide, type antioxidants, antiozonants, curatives selected from sulfur, and accelerators, titanium dioxide, reinforcing pigments selected from carbon black, zinc oxide and hydrated silicon compounds; silicon dioxide, and also a very small amount of rubber processing oil when mixed with at least one other of such compounding ingredients.

5. The package of claim 2 where said compounding ingredients are comprised of at least one of clay, silicates, calcium carbonate, tetramethylthiuram disulfide, benzothiazyl disulfide, type antioxidants, antiozonants, curatives selected from sulfur, and accelerators, titanium dioxide, reinforcing pigments selected from carbon black, zinc oxide and hydrated silicon compounds; silicon dioxide, and also a very small amount of rubber processing oil when mixed with at least one other of such compounding ingredients.

6. The package of claim 3 where said compounding ingredients are comprised of at least one of clay, silicates, calcium carbonate, tetramethylthiuram disulfide, benzothiazyl disulfide, type antioxidants, antiozonants, curatives selected from sulfur, and accelerators, titanium dioxide, reinforcing pigments selected from carbon black, zinc oxide and hydrated silicon compounds; silicon dioxide, and also a very small amount of rubber processing oil when mixed with at least one other of such compounding ingredients.

7. The package of claim 1 wherein the compounding ingredients are comprised of sulfur and sulfur cure accelerator(s) for rubber.

8. The package of claim 2 wherein the compounding ingredients are comprised of sulfur and sulfur cure accelerator(s) and sulfur cure activators for rubber.

9. The package of claim 3 wherein the compounding ingredients are comprised of sulfur and sulfur cure accelerator(s) and sulfur cure activators for rubber.

10. A compounded rubber comprised of a mixture of unsaturated rubber and the package of claim 1.

11. A compounded rubber comprised of a mixture of unsaturated rubber and the package of claim 2.

12. A compounded rubber comprised of a mixture of unsaturated rubber and the package of claim 3.

13. A compounded rubber comprised of a mixture of unsaturated rubber and the package of claim 4.

14. A compounded rubber comprised of a mixture of unsaturated rubber and the package of claim 5.

15. A compounded rubber comprised of a mixture of unsaturated rubber and the package of claim 6.

16. A compounded rubber containing the package of claim 7.

17. A compounded rubber containing the package of claim 8.

18. A compounded rubber containing the package of claim 9.

19. A method of compounding rubber by blending unvulcanized unsaturated diene-based elastomer and the package of claim 1.

20. A method of compounding rubber by blending unvulcanized unsaturated diene-based elastomer and the package of claim 2.

21. A method of compounding rubber by blending unvulcanized unsaturated diene-based elastomer and the package of claim 3.

22. A method of compounding rubber by blending unvulcanized unsaturated diene-based elastomer and the package of claim 4.

23. A method of compounding rubber by blending unvulcanized unsaturated diene-based elastomer and the package of claim 5.

24. A method of compounding rubber by blending unvulcanized unsaturated diene-based elastomer and the package of claim 6.

25. A method of compounding rubber which comprises the steps of (A) blending an unvulcanized unsaturated diene-based elastomer and rubber compounding ingredients therefor, exclusive of sulfur and sulfur cure accelerators for rubber in at least one non-productive mixing stage; and (B) in a subsequent, productive mixing stage, blending at least one package of claim 7 with such non-productive blend (A).

26. A method of compounding rubber which comprises the steps of (A) blending an unvulcanized unsaturated diene-based elastomer and rubber compounding ingredients therefor, exclusive of sulfur and sulfur cure accelerators for rubber in at least one non-productive mixing stage; and (B) in a subsequent, productive mixing stage, blending at least one package of claim 8 with such non-productive blend (A).

27. A method of compounding rubber which comprises the steps of (A) blending an unvulcanized unsaturated diene-based elastomer and rubber compounding ingredients therefor, exclusive of sulfur and sulfur cure accelerators for rubber in at least one non-productive mixing stage; and (B) in a subsequent, productive mixing stage, blending at least one package of claim 9 with such non-productive blend (A).

28. A compounded rubber prepared according to the method of claim 19.

29. A compounded rubber prepared according to the method of claim 20.

30. A compounded rubber prepared according to the method of claim 21.

31. A compounded rubber prepared according to the method of claim 22 and subsequently sulfur cured.

32. A compounded rubber prepared according to the method of claim 23 and subsequently sulfur cured.

33. A compounded rubber prepared according to the method of claim 24 and subsequently sulfur cured.

34. A compounded rubber prepared according to the method of claim 25 and subsequently sulfur cured.

35. A compounded rubber prepared according to the method of claim 26 and subsequently sulfur cured.

36. A compounded rubber prepared according to the method of claim 27 and subsequently sulfur cured.

37. A tire having a tread of the compounded rubber according to claim 10.

38. A tire having a tread of the compounded rubber according to claim 11.

39. A tire having a tread of the compounded rubber according to claim 12.

40. A tire having a tread of the compounded rubber according to claim 13.

41. A tire having a tread of the compounded rubber according to claim 14.

42. A tire having a tread of the compounded rubber according to claim 15.

43. A tire having a tread of the compounded rubber according to claim 16.

44. A tire having a tread of the compounded rubber according to claim 17.

45. A tire having a tread of the compounded rubber according to claim 18.

46. A tire having a tread of the compounded rubber according to claim 28.

47. A tire having a tread of the compounded rubber according to claim 29.

48. A tire having a tread of the compounded rubber according to claim 30.

49. A tire having a tread of the compounded rubber according to claim 31.

50. A tire having a tread of the compounded rubber according to claim 32.

51. A tire having a tread of the compounded rubber according to claim 33.

52. A tire having a tread of the compounded rubber according to claim 34.

53. A tire having a tread of the compounded rubber according to claim 35.

54. A tire having a tread of the compounded rubber according to claim 36.
